(19) United States
(12) Patent Application Publication
(10) Pub. No.: US 2006/0182875 A1
(43) Pub. Date: Aug. 17, 2006

(54) Method for manufacturing a disc-shaped information medium

(75) Inventors: Takayoshi Ose, Kanagawa (JP); Satoshi Matsubaguchi, Kanagawa (JP); Toshihiro Mandai, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/350,809

(22) Filed: Feb. 10, 2006

(30) Foreign Application Priority Data
Feb. 14, 2005 (JP) 2005-036655

(51) Int. Cl. B05D 5/12; B05D 1/36

(52) U.S. Cl. 427/58; 427/402; 427/127

(57) ABSTRACT

The present invention provides a method for manufacturing a disc-shaped information medium that has, on a substrate, a printable layer containing at least a base layer and an ink-receiving layer. The method comprises, performing a liquid spread prevention treatment at an outer peripheral region, which is from an outer peripheral end portion of the substrate to an outer peripheral end portion of the ink-receiving layer; and coating an ink-receiving layer coating liquid for forming the ink-receiving layer onto the base layer to form the printable layer.

### CROSS-REFERENCE TO RELATED APPLICATION

This application claims priority under 35USC 119 from Japanese Patent Application No. 2005-036655 the disclosure of which is incorporated by reference herein.

### BACKGROUND OF THE INVENTION

1. Field of the Invention

The present invention relates to a method for manufacturing disc-shaped information medium provided with a printable layer on which characters and photographs can be printed.

2. Description of the Related Art

CDs (compact discs) and DVDs (digital versatile discs) are widely accepted as standardized information recording media in the marketplace.

Examples of CDs include CD-ROMs from which information can only be read, write-once type CD-Rs on which information is capable of being recorded only once, and rewritable CD-RWs on which information be rewritten numerous times.

The CD-ROMs have, for example, a structure in which a row of pits are formed at a track pitch of 1.6 μm on a transparent substrate having a diameter of 120 mm and a thickness of 1.2 mm, and have a recording capacity of about 650 MB. Information can be reproduced by irradiating the CD-ROMs with laser light having a wavelength of 770 to 790 nm at a constant linear velocity of 1.2 to 1.4 m/s.

The DVDs include DVD-ROMs, DVD-Rs, and DVD-RWs similarly to the CDs.

The DVD-ROMs have a recording density about 6 to 8 times that of the CDs and have, for example, a structure in which two substrates having a thickness of about 0.6 mm are applied to each other, wherein, for example, pits are formed at a track pitch of 0.74 μm and information can be reproduced by irradiating the DVD-ROMs with laser light having a wavelength of 635 to 650 nm at a constant linear velocity of about 3.5 m/s.

In the fields of CDs and DVDs, information media have been recently developed which are provided with a printable layer formed on the surface (label side) opposite to the information-reproducible surface, such that an image can be printed by an ink jet printer (see, for example, Japanese Patent Application Laid-Open (JP-A) No. 2002-245671). An ultraviolet ray-curable resin is generally used for the printable layer of such an information medium.

On the other hand, when the printable layer (in particular, an ink-receiving layer) is formed in a region from 11 mm in a diameter direction from a disc center to 2 mm from an outer peripheral end portion of the disc by coating method, as a coating method thereof, an extrusion die coater method and a curtain coating method are known. The viscosity of a coating liquid that is used in the coating method is low as 5 CP to 500 CP Accordingly, the coating liquid partially goes slack in particular at an outer peripheral end portion surface of an optical disc to be thin in the film thickness, resulting in causing a problem in that a coated film having a uniform thickness is not obtained. Furthermore, the coating liquid gone slack at the outer peripheral end portion surface goes round to a backside of the disc to contaminate the disc, resulting in causing a problem in that defects are caused.

### SUMMARY OF THE INVENTION

The present invention can provide a method for manufacturing a disc-shaped information medium, which, when an ink-receiving layer is formed on a label side to manufacture a disc-shaped information medium, at the time of coating an ink-receiving layer coating liquid or of drying after the coating, can prevent the ink-receiving layer coating liquid from going slack to an outer peripheral end portion surface and thereby can uniformize a thickness of a coated film.

A first aspect of the invention is to provide a method for manufacturing a disc-shaped information medium that has, on a substrate, a printable layer containing at least a base layer and an ink-receiving layer, the method comprising:

performing a liquid spread prevention treatment at an outer peripheral region from an outer peripheral end portion of the substrate to an outer peripheral end portion of the ink-receiving layer; and

coating an ink-receiving layer coating liquid for forming the ink-receiving layer onto the base layer to form the printable layer.

### BRIEF DESCRIPTION OF THE DRAWINGS

FIG. 1A is a diagram that explains a method for forming a printable layer and shows a state where a convex portion is formed on a substrate.

FIG. 1B is a diagram that explains a method for forming a printable layer and shows a state where an ink-receiving layer is formed.

FIG. 1C is a diagram that explains a method for forming a printable layer and shows a state where a convex portion is formed on a substrate.

FIG. 1D is a diagram that explains a method for forming a printable layer and shows a state where a convex portion is formed in an inner peripheral region.

FIG. 2 is a diagram for explaining another method for forming a printable layer.

FIG. 3A is a diagram that explains another method for forming a printable layer and shows a state before a convex portion is disposed on a substrate.

FIG. 3B is a diagram that explains another method for forming a printable layer and shows a state where a convex portion is formed on a substrate.

FIG. 3C is a diagram that explains another method for forming a printable layer and shows a state where a convex portion is disposed in an inner peripheral region.

### DETAILED DESCRIPTION OF THE INVENTION

As information media manufactured according to the method for manufacturing a disc-shaped information medium (hereinafter, in some cases, simply referred to as “information media”) of the present invention, a magnetic medium such as a magnetic recording medium, an optical medium such as an optical information recording medium and a semiconductor medium can be cited. In particular, an optical information recording medium is preferable. As a shape of the optical information recording medium, a disc-shaped one and cartridge housing one may be used. In the case of the cartridge housing type, removable one is preferable. On a label side (mainly, in the case of a DVD structure, a label side is disposed on a substrate or a protective substrate, and, in the case of a CD structure, a label side is disposed on a protective layer) of such information medium, a printable layer is formed.

In the case where the information medium is an optical disc, it may be any one of discs including CDs, DVDs and optical discs using a bluish violet laser to record and reproduce information.

In the case of a medium using a bluish violet laser to record, it may be any one of an applied type (HDD DVD) such as DVDs and a type (Blue-Ray Disc) provided with a recording layer and a cover layer on a substrate having a thickness of 1.1 mm wherein laser light is introduced from the cover layer side.

The information medium of the invention is preferably a write-once type, though it may be any of a ROM type, a rewritable type and a write-once type.

The printable layer is generally formed on the side opposite to the surface from which laser light is introduced. However, the printable layer can be formed on the side from which laser light is introduced if it is formed on an area other than an area from which the laser is introduced.

According to a manufacturing method for an information medium of the invention, a printable layer that contains, on a substrate, at least a base layer and an ink-receiving layer is formed and thereby to manufacture a disc-shaped information medium. The method will be described with reference to the drawings.

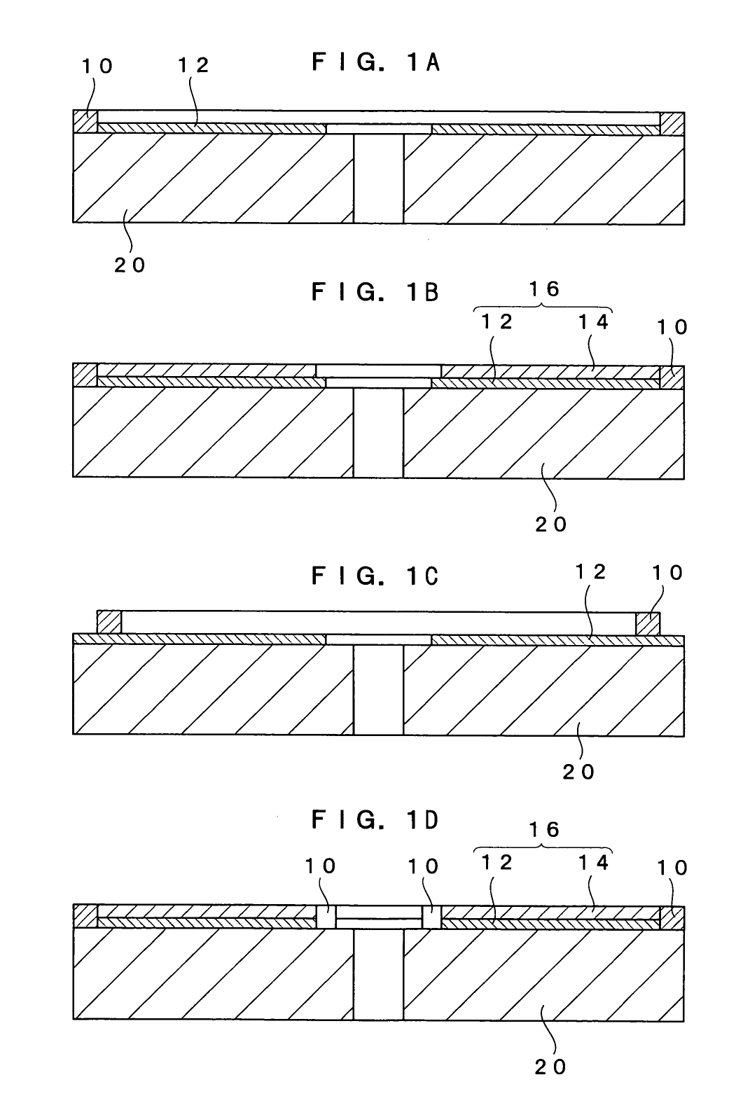

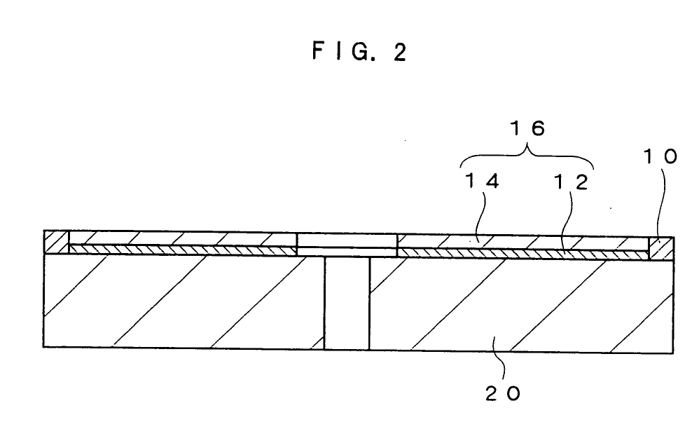

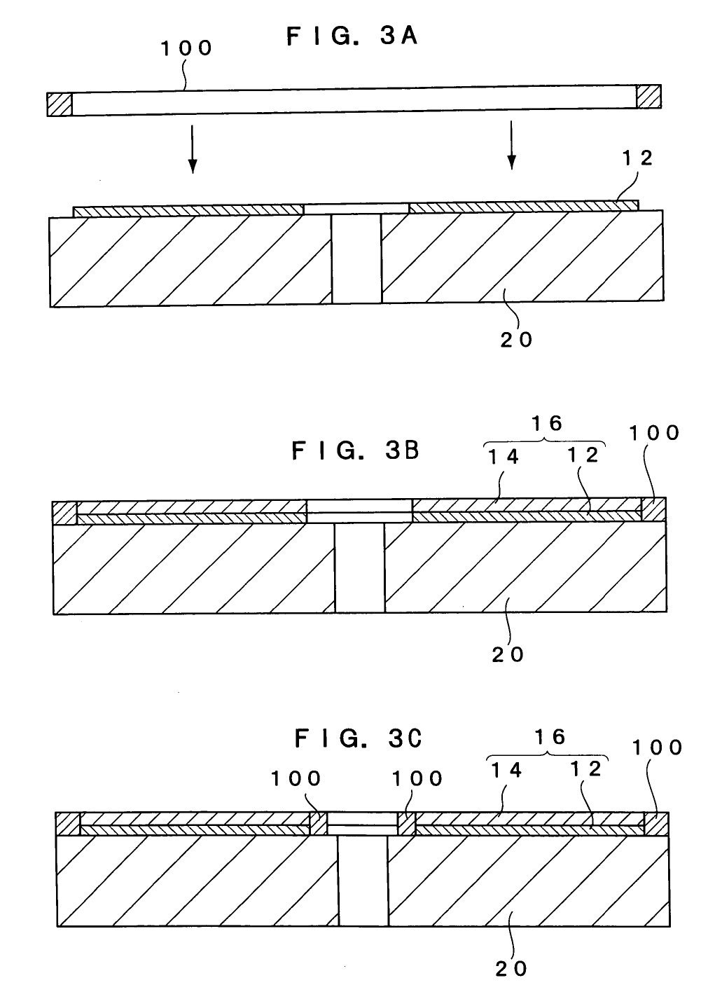

As shown in FIG. 1A, on a label side of a substrate 20, in an outer peripheral region from an outer peripheral end portion of the substrate to an outer peripheral end portion of the ink-receiving layer when an ink-receiving layer is formed, an annular convex portion 10 is disposed to prevent the liquid from spreading (liquid spread prevention treatment). Thereafter, as shown in FIG. 1B, on an inner peripheral side than the convex portion 10, a base layer 12 is formed. On the base layer 12, an ink-receiving layer coating liquid for forming an ink-receiving layer 14 is coated to form a printable layer 16 (forming a printable layer process) and thereby an information medium is manufactured. On the substrate opposite to a surface where a printable layer is formed, layers such as a recording layer and a light reflective layer are appropriately formed (similar also in the cases of FIG. 2 and FIGS. 3A to 3C). Furthermore, the “liquid spread prevention treatment” means a treatment that prevents the coating liquid from spreading to an outer peripheral end portion surface and an inner peripheral end portion surface of the substrate when a coating liquid is coated to form an ink-receiving layer.

The ink-receiving layer 14 can be formed when an ink-receiving layer coating liquid is coated by use of an extrusion die coater method or a curtain coating method. The ink-receiving layer coating liquid is in a low viscosity state under ordinary coating conditions. However, as shown in FIGS. 1A to 1C, when the liquid spread prevention treatment is performed at the time of coating the ink-receiving layer coating liquid or at the time of drying after the coating, the ink-receiving layer coating liquid can be prevented from going slack to an end surface of the substrate 20 (a disc end surface). As a result, the liquid can be prevented from flowing toward an outer peripheral direction to be low in height of an end surface. Furthermore, the convex portion as the liquid spread prevention treatment plays a role of damming a flow of the ink-receiving layer coating liquid toward an outer peripheral end portion, resulting in preventing the unevenness of a thickness of the ink-receiving layer between the outer peripheral end portion side and other portions.

In the case of a aspect shown in FIG. 1, as shown in FIG. 1C, after a base layer 12 is formed on the substrate up to an outer peripheral end portion thereof by means of a screen printing method, on the base layer 12, a liquid spread prevention treatment (a convex portion 10) may be performed in the outer peripheral region. In this case, as the liquid spread prevention treatment, similarly to the case where the base layer is formed, with a material the same as the base layer, a convex portion 10 may be disposed with the screen printing method.

In the liquid spread prevention treatment, a convex portion 10 may be disposed not only in an outer peripheral region as shown in FIG. 1D but also in an inner peripheral region from an inner peripheral end portion of the substrate to an inner peripheral end portion of the ink-receiving layer. By disposing convex portion 10 in the inner peripheral region, the liquid can be excellently prevented from going slack toward the inner peripheral end portion and thereby over an entirety from the outer peripheral end portion side to the inner peripheral end portion side the ink-receiving layer can be suppressed from fluctuating in the thickness.

Furthermore, as the liquid spread prevention treatment, when a convex portion is directly disposed on a label side of the substrate, it becomes an aspect as shown in FIG. 2 (in FIG. 2, like portions as FIG. 1 are given like reference numerals). That is, when a substrate 20 is formed, a convex portion 10 is formed in advance, and thereby the substrate 20 and the convex portion 10 are continuously formed. In this state, a base layer 12 and an ink-receiving layer 14 are sequentially formed. As mentioned above, in a so-called inner peripheral region as well, the convex portion may be disposed.

As the liquid spread prevention treatment, a treatment such as shown in FIGS. 3A to 3C may be disposed. That is, after a base layer 12 is formed on a label side of the substrate 20, in an outer peripheral region from an outer peripheral end portion of the substrate 20 to an outer peripheral end portion of the ink-receiving layer 14, an annular frame 100 as the liquid spread prevention treatment is disposed (FIG. 3A). Then, as shown in FIG. 3B, on the base layer 12, an ink-receiving layer coating liquid for forming an ink-receiving layer 14 is coated to form a printable layer 16 (forming a printable layer process). Thereafter, the frame 100 is removed and thereby an information medium is manufactured. In FIGS. 3A to 3C, portions corresponding to FIGS. 1A to 1C are imparted with the same reference numerals.

In the case of a measure of disposing the frame 100 being adopted, when the printable layer 16 is formed and the frame 100 is removed, end surfaces of the printable layer 16 are likely to be bruised. In this connection, to a contact surface of the frame 100 that comes into contact with the end surfaces of the printable layer 16, a removing treatment is preferably performed. As mentioned above, as shown in FIG. 3C, to a so-called inner peripheral region as well, a frame 100 may be disposed.

When the liquid spread prevention treatment is a treatment that involves forming a convex portion, a height of the convex portion is not necessarily higher than a height of the receiving layer. This is because as far as the coating liquid for forming the ink-receiving layer does not spread to an end surface of the substrate, that is, as far as the coating liquid stays on the convex portion and does not spread to the end face, an object of the liquid spread prevention treatment can be achieved. However, when the practicality is considered, the height of the convex portion and the thickness of the ink-receiving layer are preferably substantially same. The “substantially same” means that when a thickness of the ink-receiving layer is represented by “×”, a height of the convex portion is in the range of 1.0× to 1.2×. it is preferably in the range of 10× to 11×. A preferable specific height of the convex portion is in the range of 10 to 120 μm, more preferably in the range of 10 to 40 μm and furthermore preferably in the range of 25 to 32 μm. Furthermore, the maximum width (the maximum length in a diameter direction) is preferably in the range of 0.1 to 0.5 mm and more preferably in the range of 0.2 to 0.4 mm. As the sectional shape of the convex portion, without restricting to rectangular shapes as shown in FIGS. 1 to 3, various shapes such as a triangular shape or a spherical shape can be applied. Furthermore, FIGS. 1A to 1C through FIGS. 3A to 3C are exaggerated to make understandable.

The convex portion formed on the substrate can be formed directly on a label side of the substrate or on a base layer formed on the substrate by means of a screen printing method with a UV-curable resin (for instance, a UV-curable resin that is used to form a base layer). Furthermore, with a groove disposed to a predetermined place of a substrate molding die for use in injection molding, the injection molding can be applied to form. Still furthermore, the frames that are shown in FIGS. 3A to 3C can be prepared by use of known molding methods.

The printable layer of the information medium manufactured according to the method of the invention can be formed as mentioned above. In what follows, while describing a constitution of the printable layer, a method for forming a printable layer will be more detailed and furthermore a recording layer disposed to the information medium will be described as well.

The printable layer formed according to the method of the invention includes at least a base layer and an ink-receiving layer. In what follows, in the beginning, the respective layers of the printable layer will be described.

Base Layer

A base layer is formed between the ink receiving layer and the substrate in accordance with necessity. When the information medium has a highly opaque base layer, it has diffusibility close to that of paper, improving image quality. In particular, when the information medium has a white base layer, color reproducibility can be improved. When the information medium has a base layer with high glossiness, an image formed thereon is like a glossy photograph. When the information medium has a base layer with a highly matting property, an image formed thereon is like a matt photograph. When various colors are used for the base layer, images having a variety of impressions can be formed. In the case of a fluorescent base layer, a fluorescent image can be made. Although there is no particular limitation to a method of forming such a base layer, it is preferable to form a radiation-curable resin layer by screen printing from the viewpoint of productivity. The radiation-curable resin is one cured by an electromagnetic wave such as ultraviolet rays, electron beams, X-rays, γ-rays or infrared rays. Among these radiation rays, ultraviolet rays and electron beams are preferable as the radiation.

The thickness of the base layer is preferably 0.1 to 100 μm, more preferably 1 to 50 μm, and most preferably 3 to 20 μm.

Ink Receiving Layer

The ink-receiving layer according to the invention has a thickness in the range of 20 to 50 μm. The ink-receiving layer preferably comprises at least particles, a binder and a cross-linking agent, and, as needs arise, a compound represented by a formula (1) and/or a compound represented by a formula (2) both described below and various kinds of additives. In the beginning, the aforementioned materials will be described.

Particles

Examples of the particles include a vapor-phase-process silica, pseudo boehmite, aluminum oxide, titanium dioxide, barium sulfate, calcium silicate, zeolite, kaolinite, halloysite, mica, talc, calcium carbonate, magnesium carbonate, calcium sulfate and boehmite. Among these particles, a vapor-phase-process silica, pseudo boehmite and aluminum oxide are preferable.

Vapor-Phase-Process Silica

Silica particles are roughly classified into wet method particles and dry method (vapor phase process) particles in general by its production method. In the wet method, a method in which a silicate is decomposed by an acid to produce active silica, the active silica is then moderately polymerized, and the polymerized silica is aggregated and precipitated to obtain hydrated silica is mainly used. As the vapor phase process which are currently and dominantly used, there are a method in which a silicon halide is subjected to high-temperature vapor phase hydrolysis (flame hydrolysis method), and a method (arc method) in which quarts sand and cokes are heated, reduced and vaporized by an arc in an electric furnace and the vaporized materials are oxidized with air. The “vapor-phase-process silica” means silica anhydride particles obtained by the vapor phase process.

The vapor-phase-process silica is suitable to form a three-dimensional structure having high percentage of void, though it is different from hydrated silica in density of silanol groups on the surfaces of particles and presence or absence of voids, and exhibits properties different from those of hydrated silica. The reason for this is not clarified, but is thought as follows. In the case of hydrated silica, the density of silanol groups on the surface of particles is as many as 5 to 8 groups/nm² and therefore silica particles easily densely aggregate. Meanwhile, in the vapor-phase-process silica, the density of silanol groups on the surfaces of particles is as small as 2 to 3 groups/nm² and therefore silica particles thin flocculate and, as a result, form a structure having high percentage of void.

The vapor-phase-process silica has high ink absorbing ability and high retention efficiency due to its large specific surface area. Also, because this silica has a low refractive index, it can impart transparency to the ink receiving layer by dispersing it till it has a proper diameter and can provide a high color density and a good color developing property.

An average primary particle diameter of the vapor-phase-process silica particles is preferably 30 nm or less, more preferably 20 nm or less, still more preferably 10 nm or less, and most preferably 3 to 10 nm. The vapor-phase-process silica particles tend to adhere to each other due to hydrogen bond of their silanol groups. Therefore, when the average primary particle diameter is 30 nm or less, the vapor-phase-process silica can form a structure having high percentage of void and can effectively improve an ink absorbing property.

A solid content of the aforementioned vapor-phase-process silica particles in the ink receiving layer is preferably 40% by mass or more, and more preferably 50% by mass or more based on a total solid amount of the ink receiving layer. When the content exceeds 50% by mass, it becomes possible to form a better porous structure, enabling an ink receiving layer having sufficient ink absorbing ability. The solid content of the vapor-phase-process silica particles in the ink receiving layer herein means the content of the vapor-phase-process silica particles calculated on the basis of components other than water in the composition of the ink receiving layer.

Other inorganic pigment particles such as hydrated silica particles, colloidal silica, titanium dioxide, barium sulfate, calcium silicate, zeolite, kaolinite, halloysite, mica, talc, calcium carbonate, magnesium carbonate, calcium sulfate, boehmite and pseudo boehmite may also be additionally used. When other inorganic pigment particles and the vapor-phase-process silica are used in combination, a content of the vapor-phase-process silica in a total amount of inorganic pigment particles is preferably 50% by mass or more, and more preferably 70% by mass or more.

Pseudo Boehmite

The pseudo boehmite is a stratified compound which is represented by Al₂O₃.xH₂O (1<x<2) and whose crystal has a (020) plane forming a huge plane and has a lattice constant d of 0.67 nm. Here, the pseudo boehmite has a structure including excess water between layers of the (020) plane. The pseudo boehmite well absorbs ink and is fixed. It can also improve ink absorbing ability and prevent blurring over time.

A sol-like pseudo boehmite (pseudo boehmite sol) is preferably used as a raw material because a smooth layer is easily obtained.

An average primary particle diameter of the pseudo boehmite particles is preferably 50 nm or less, more preferably 30 nm or less and particularly preferably in a range of 3 to 20 nm. When the average primary particle diameter is within the above range, a structure having high percentage of void can be formed and the ink absorbing ability of the ink receiving layer can be further improved. The average primary particle diameter can be measured with, for example, an electron microscope.

The BET specific surface area of each of the pseudo boehmite particles is preferably in a range of 40 to 500 m²/g and more preferably in a range of 200 to 500 m²/g.

Moreover, an aspect ratio of each of the pseudo boehmite particles is preferably in a range of 3 to 10. As for a porous structure of the pseudo boehmite, an average pore radius thereof is preferably in a range of 1 to 30 nm, and more preferably 2 to 15 nm. A pore volume of the pseudo boehmite is preferably in a range of 0.3 to 2.0 ml/g (cc/g), and more preferably 0.5 to 1.5 ml/g (cc/g). Here, the pore radius and pore volume are measured by a nitrogen absorption and desorption method. For example, they may be measured with a gas absorption and desorption analyzer, for example, OMNISOAP™369 (trade name, manufactured by Beckman Coulter, Inc.).

A solid content of the aforementioned pseudo boehmite particles in the ink receiving layer is preferably 50% by mass or more, and more preferably 60% by mass or more based on a total solid amount of the ink receiving layer. When the content exceeds 60% by mass, it becomes possible to form a better porous structure, enabling an ink receiving layer having sufficient ink absorbing ability. The solid content of the pseudo boehmite particles in the ink receiving layer herein means the content of the pseudo boehmite particles calculated on the basis of components other than water in the composition of the ink receiving layer.

The pseudo boehmite is preferably used in a form of a dispersion liquid in which it is dispersed in an aqueous solvent. A content of the pseudo boehmite in the dispersion liquid is preferably 60% by mass or less, more preferably 5 to 60% by mass, and most preferably 10 to 50% by mass.

The pseudo boehmite can be dispersed particularly effectively when the content is in the above range. For example, thickening and gelation caused by, for example, a reduction in the distance between the pseudo boehmite particles can be effectively suppressed.

A mass ratio of the vapor-phase-process silica (S) to the pseudo boehmite (A), namely (S:A), is preferably in a range of 95:5 to 5:95, more preferably in a range of from 80:20 to 20:80, and most preferably in a range of 70:30 to 30:70.

When the vapor-phase-process silica is used in combination with the pseudo boehmite within the above range of the content ratio, blurring of all inks of plural colors over time can be effectively prevented regardless of hue. Even when a multicolor image is formed, a clear image with high resolution can be formed and kept.

Aluminum Oxide

Examples of aluminum oxide include anhydrous alumina such as α-alumina, δ-alumina, θ-alumina and χ-alumina and active aluminum oxide. δ-Alumina is preferable among them.

From the viewpoint of a production method, alumina particles produced by a vapor phase process, namely, vapor phase process alumina particles obtained by hydrolyzing a gaseous metal chloride in a presence of water generated in an oxy-hydrogen reaction or at a temperature that is characteristic in such a reaction are preferable because the particles have a high specific surface area.

The form of the aluminum oxide can be, for example, particles, particles, ultra particles, powders, impalpable powders, or ultra fine powders having predetermined particle diameters. An average primary particle diameter of these particles is preferably 200 nm or less, more preferably 5 to 100 nm, and particularly preferably 5 to 20 nm. When the average primary particle diameter of the alumina particles is in the above range, a structure having high percentage of void can be formed and the ink absorbing ability of the ink receiving layer can be further improved. It is noted that the average primary particle diameter can be measured with, for example, an electron microscope.

The aluminum oxide is preferably used in a form of a dispersion liquid. A content of aluminum oxide in the dispersion liquid is preferably 60% by mass or less, more preferably 5 to 60% by mass, and most preferably 10 to 50% by mass. When the content of aluminum oxide is in the above range, aluminum oxide can be more effectively dispersed. When the content of aluminum oxide in the dispersion solution is 60% by mass or less, it is possible to effectively suppress thickening and gelation caused by, for example, a reduction in the distance between the aluminum oxide particles in the dispersion liquid.

Primary to tertiary amino groups and salts thereof and/or a cationic polymer having a quaternary ammonium base may be added as an aggregation inhibitor to the dispersion liquid. An amount of the aggregation inhibitor to be added is preferably 1 to 10% by mass, and more preferably 1 to 5% by mass based on the total amount of aluminum oxide particles. When the amount of the inhibitor is less than 1% by mass, dispersibility may deteriorate. Meanwhile, when the amount exceeds 10% by mass, decreased color density may be obtained at the time that an image is printed on the ink receiving layer.

A solid content of the aforementioned aluminum oxide in the ink receiving layer is preferably 50% by mass or more, and more preferably 60% by mass or more based on a total solid amount of the ink receiving layer. When the content exceeds 60% by mass, it becomes possible to form a better porous structure, enabling an ink receiving layer having sufficient ink absorbing ability. The solid content of the aluminum oxide in the ink receiving layer herein means the content of the aluminum oxide calculated on the basis of components other than water in the composition of the ink receiving layer.

The aluminum oxide may be combined with other particles. When aluminum oxide is combined with other particles, the content of aluminum oxide in all particles is preferably 30% by mass or more, and more preferably 50% by mass or more.

The particles may be any of organic particles and inorganic particles, and among them, inorganic particles are preferable from the viewpoint of ink absorbing ability and image stability.

Binder

As mentioned above, the ink receiving layer preferably contains a binder. The binder is preferably a water-soluble resin.

Examples of the water-soluble resin include polyvinyl alcohol resins, which have hydroxyl groups as hydrophilic structural units (e.g., a polyvinyl alcohol (PVA), acetoacetyl modified PVA, cation modified PVA, anion modified PVA, silanol modified PVA and polyvinylacetal), cellulose resins (e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose], chitins, chitosans, starch, resins having ether bonds [e.g., a polyethylene oxide (PEO), polypropylene oxide (PPO), polyethylene glycol (PEG) and polyvinyl ether (PVE)] and resins having carbamoyl groups [e.g., a polyacrylamide (PAAM), polyvinylpyrrolidone (PVP) and polyacrylic acid hydrazide.

As the water-soluble resin, polyacrylates, maleic acid resins, alginates and gelatins having carboxy groups as dissociable groups may also be utilized.

Among the above resins, polyvinyl alcohol (PVA) resins are particularly preferable. Examples of the polyvinyl alcohol resins include those described in Japanese Patent Application Publication (JP-B) Nos. 4-52786, 5-67432 and 7-29479, Japanese Patent No. 2537827, JP-B No. 7-57553, Japanese Patent Nos. 2,502,998 and 3,053,231, JP-A No. 63-176173, Japanese Patent No. 2,604,367, JP-A Nos. 7-276787, 9-207425, 11-58941, 2000-135858, 2001-205924, 2001-287444, 62-278080 and 9-39373, Japanese Patent No. 2,750,433, JP-A Nos. 2000-158801, 2001-213045, 2001-328345, 8-324105 and 11-348417.

Examples of the water-soluble resin other than the polyvinyl alcohol resins include compounds described in JP-A No. 11-165461, paragraph Nos. [0011] to [0014].

These water-soluble resins as binders may be used singly or in combination of two or more of them.

In the invention, a content of the water-soluble resin is preferably 9 to 40% by mass, and more preferably 12 to 33% by mass based on a total solid mass of the ink receiving layer.

The polyvinyl alcohol resin may be used in combination with any of the aforementioned other water-soluble resins. When other water-soluble resin is used in combination with the polyvinyl alcohol resin, the content of the polyvinyl alcohol resin is preferably 50% by mass or more, and more preferably 70% by mass or more based on a total amount of the water-soluble resins.

The polyvinyl alcohol resin has a hydroxyl group in the structural unit thereof. This hydroxyl groups and the silanol groups on the surfaces of silica particles form hydrogen bond, which makes it easy to form a three-dimensional network structure in which secondary particles of the silica particles are chain units. It is thought that the formation of the three-dimensional network structure makes it possible to form an ink receiving layer having a porous structure with high percentage of void.

In the ink jet recording, the porous ink receiving layer thus obtained can rapidly absorb ink due to capillarity to form good circular dots free from ink blurring.

Polyvinyl alcohol resin having a degree of saponification of 70 to 99% is more preferable, and polyvinyl alcohol resin having a degree of saponification of 80 to 99% is particularly preferable from the viewpoint of transparency.

Ratio of Particles to Water-Soluble Resin (Binder)

The ratio by mass (PB ratio (x/y)) of the particles (x) relative to the water-soluble resin as the binder (y) largely affects a structure and strength of the ink receiving layer. That is, when the mass ratio (PB ratio) is increased, percentage of void, pore volume and surface area (per unit mass) are increased, but the density and strength tend to be decreased.

In the ink receiving layer, the mass ratio (PB ratio (x/y)) is preferably 1.5/1 to 10/1 from the viewpoint of prevention of defects caused by a too large PB ratio such as a reduction in layer strength and cracks at the time of drying, and prevention of deteriorated ink absorbing ability caused by a too small PB ratio, namely caused by voids being easily clogged with a resin and therefore percentage of void being reduced.

When the information medium of the invention is conveyed through a conveyor system of an ink jet recording printer, stress may be applied to the information medium. Accordingly, it is preferable that the ink receiving layer has a sufficient film strength. In consideration of such cases, the PB ratio (x/y) is preferably 4/1 or less. On the other hand, the PB ratio (x/y) is preferably 3/1 or more from the viewpoint of assuring of high-speed ink absorbing ability in an ink jet recording printer.

Cross-Linking Agent

The ink receiving layer preferably contains a cross-linking agent which can cross-link the binder. When the cross-linking agent is contained, the ink receiving layer can be formed as a porous layer cured by cross-linking reaction between the cross-linking agent and the binder.

A boron compound is preferable to cross-link a polyvinyl alcohol which is particularly preferable as the water-soluble resin as a binder. Examples of the boron compound include borax, boric acid, borates (e.g., orthoborates, InBO₃, ScBO₃, YBO₃, LaBO₃, Mg₃(BO₃)₂, Co₃(BO₃)₂, diborates (e.g., Mg₂B₂O₅ and Co₂B₂O₅), methaborates (e.g., LiBO₂, Ca(BO₂)₂, NaBO₂ and KBO₂), tetraborates (e.g., Na₂B₄O₇.10H₂O) and pentaborates (e.g., KB₅O₈.4H₂O, Ca₂B₆O₁₁.7H₂O and CsB₅O₅). Among these boron compounds, borax, boric acid and borates are preferable, and boric acid is particularly preferable from the viewpoint of rapid initiation of cross-linking reaction.

As the cross-linking agent for the water-soluble resin as a binder, a compound other than the boron compound may also be used. Examples of such a cross-linking agent include aldehyde compounds such as formaldehyde, glyoxal, succinaldehyde, glutaraldehyde, dialdehyde starch and dialdehyde derivatives of vegetable gum; ketone compounds such as diacetyl, 1,2-cyclopentanedione and 3-hexene-2,5-dione; active halogen compounds such as bis(2-chloroethyl)urea, bis(2-chloroethyl)sulfone and sodium salt of 2,4-dichloro-6-hydroxy-s-triazine; active vinyl compounds such as divinylsulfone, 1,3-bis(vinylsulfonyl)-2-propanol, N,N′-ethylenebis(vinylsulfonylacetamide), divinyl ketone, 1,3-bis(acryloyl)urea and 1,3,5-triacryloyl-hexahydro-s-triazine; N-methylol compounds such as dimethylolurea and methyloldimethylhydantoin; melamine compounds such as trimethylolmelamine, alkylated methylolmelamine, melamine, benzoguanamine and melamine resins; epoxy compounds such as ethylene glycol diglycidyl ether, propylene glycol diglycidyl ether, polyethylene glycol diglycidyl ether, diglycerin polyglycidyl ether, spiroglycol diglycidyl ether and polyglycidyl ether of a phenol resin; isocyanate compounds such as 1,6-hexamethylene diisocyanate and xylylene diisocyanate; aziridine compounds described in U.S. Pat. Nos. 3,017,280 and 2,983,611; carbodiimide compounds described in U.S. Pat. No. 3,100,704; ethyleneimino compounds such as 1,6-hexamethylene-N,N′-bisethyleneurea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate and chromium acetate; polyamine compounds such as tetraethylenepentamine; hydrazide compounds such as dihydrazide adipate; low molecular-weight molecules and polymers containing two or more oxazoline groups; anhydrides of polyvalent acids, acid chlorides and bissulfonate compounds described in U.S. Pat. Nos. 2,725,294, 2,725,295, 2,726,162 and 3,834,902 and active ester compounds described in U.S. Pat. Nos. 3,542,558 and 3,251,972.

One of these cross-linking agents may be used singly or in combination of two or more of them.

When a gelatin is used in addition to the polyvinyl alcohol, following compounds, which are known as a film hardening agent for gelatin, can be used as a cross-linking agent in addition to the boron compound. Examples of such a cross-linking agent for gelatin include aldehyde compounds such as formaldehyde, glyoxal, and glutaraldehyde; ketone compounds such as diacetyl and cyclopentanedione; active halogen compounds such as bis(2-chloroethylurea)-2-hydroxy-4,6-dichloro-1,3,5-triazine and sodium salt of 2,4-dichloro-6-S-triazine; active vinyl compounds such as divinylsulfonic acid, 1,3-vinylsulfonyl-2-propanol, N,N′-ethylenebis(vinylsulfonylacetamide), and 1,3,5-triacryloyl-hexahydro-S-triazine; N-methylol compounds such as dimethylolurea and methyloldimethylhydantoin; isocyanate compounds such as 1,6-hexamethylene diisocyanate; aziridine compounds described in U.S. Pat. Nos. 3,017,280 and 2,983,611; carbodiimide compounds described in U.S. Pat. No. 3,100,704; epoxy compounds such as glycol triglycidyl ether; ethyleneimino compounds such as 1,6-hexamethylene-N,N′-bisethyleneurea; halogenated carboxyaldehyde compounds such as mucochloric acid and mucophenoxychloric acid; dioxane compounds such as 2,3-dihydroxydioxane; chrome alum, potassium alum, zirconium sulfate, chromium acetate; and the like.

When the boron compound and other cross-linking agents are used in combination, a content of the boron compound in all cross-linking agents is preferably 50% by mass or more, and is preferably 70% by mass or more based on a total amount of the all cross-linking agents.

The boron compound may be used singly or in combination of two or more of them.

The cross-linking agent is preferably supplied simultaneously with application of a coating solution which at least contains the particles and the binder and which forms the porous ink receiving layer (namely, an ink receiving layer coating solution), or before the coating layer formed by applying the ink receiving layer coating solution exhibits a decreasing rate of dry speed. This operation is effective to prevent generation of cracks when the coating layer is dried.

That is, by applying the cross-linking agent-containing solution to the coating layer at a timing of simultaneously with the application of the coating solution or at a timing of before the coating layer exhibits a decreasing rate of dry speed, the cross-linking agent-containing solution penetrates into the coating layer and quickly reacts with the binder in the coating layer to allow the binder to be made gel state (cured), whereby a strength of the coating layer is rapidly and remarkably improved.

Further, examples of methods of forming an ink receiving layer used in the invention include a method in which a solution (first solution), which contains the binder and the compound represented by formula (1) and/or the compound represented by formula (2), is added to an aqueous dispersion containing the particles and the dispersant and re-dispersed to obtain a coating solution, the coating solution is applied to a surface of the base layer, and a solution (second solution) containing the cross-linking agent is applied to the coating layer simultaneously with the application of the coating solution or during the course of drying of the resultant coating layer and before the coating layer exhibits a decreasing rate of dry speed. When this method is used, the cross-linking agent is preferably added to both the first and second solutions.

When the cross-linking agent is applied, its solution is prepared by dissolving the cross-linking agent in water and/or an organic solvent.

A concentration of the cross-linking agent in the cross-linking agent solution is preferably 0.1 to 10% by mass, and more preferably 0.5 to 8% by mass based on the mass of the cross-linking agent solution.

Water is generally used as the solvent of the cross-linking agent solution, and an aqueous mixture solvent containing water and an organic solvent miscible with water may also be used.

Any solvent which dissolves the cross-linking agent may be used as the organic solvent. Examples of the organic solvent include alcohols such as methanol, ethanol, isopropyl alcohol and glycerin; ketones such as acetone and methyl ethyl ketone; esters such as methyl acetate and ethyl acetate; aromatic solvents such as toluene; ethers such as tetrahydrofuran; and halogenated carbon-including solvents such as dichloromethane.

Mordant

The ink receiving layer in the invention preferably contains a mordant to improve water resistance of a formed image and prevent blurring of the formed image over time.

A cationic polymer (cationic mordant) is preferable as the mordant. Presence of the mordant in the ink receiving layer can improve water resistance and prevent blurring over time because the mordant interacts with liquid ink having an anionic dye as a colorant to stabilize the colorant.

However, if the mordant is directly added to the coating solution for forming the ink receiving layer (the ink receiving layer coating solution), the mordant and the vapor-phase-process silica having an anionic charge may aggregate. Use of a method, in which the mordant is used as another solution, and in which the solution is separately applied, does not cause such aggregation of the inorganic pigment particles. Therefore, in the invention, the mordant is preferably contained in a solution other than the dispersion of the vapor-phase-process silica (for example, a cross-linking agent solution).

As the cationic mordant, a polymer mordant containing as a cationic group any of primary to tertiary amino groups and a quaternary ammonium base is preferably used. A cationic non-polymer mordant may also be used.

Preferable examples of the polymer mordant include a homopolymer of a monomer (mordant monomer) containing any of primary to tertiary amino groups and salts thereof and a quaternary ammonium base, and a copolymer or a condensed polymer of the mordant monomer and any other monomer (hereinafter referred to as “non-mordant monomer”). These polymer mordants may be used in any form including a water-soluble polymer and water-dispersible latex particles.

Examples of the mordant monomer include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride; trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate; and quaternary products of N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide or N,N-diethylaminopropyl(meth)acrylamide, and methyl chloride, ethyl chloride, methyl bromide, ethyl bromide, methyl iodide or ethyl iodide, and sulfonates, alkylsulfonates, acetates and alkylcarboxylates obtained by substituting the anions of these products.

Specific example of these salts include trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride; N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate and trimethyl-3-(acryloylamino)propylammonium acetate.

Examples of other copolymerizable monomers include N-vinylimidazole and N-vinyl-2-methylimidazole.

The non-mordant monomer means a monomer which contains no basic or cationic moiety such as a primary to tertiary amino group or a salt thereof or a quaternary ammonium base and which does not interact or hardly interacts with the dye contained in ink jet ink.

Examples of the non-mordant monomer include alkyl(meth)acrylates; cycloalkyl(meth)acrylates such as cyclohexyl(meth)acrylate; aryl(meth)acrylates such as phenyl(meth)acrylate; aralkyl esters such as benzyl(meth)acrylate; aromatic vinyls such as styrene, vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

As the alkyl(meth)acrylate, alkyl(meth)acrylates with an alkyl moiety having 1 to 18 carbon atoms are preferable. Examples of the preferable alkyl(meth)acrylates include methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate and stearyl(meth)acrylate.

Among these compounds, methyl acrylate, ethyl acrylate, methyl methacrylate, ethyl methacrylate and hydroxyethyl methacrylate are preferable.

The non-mordant monomers may be used singly or in combination of two or more of them.

Furthermore, preferable examples of the polymer mordant include polydiallyldimethylammonium chloride, polymethacryloyloxyethyl-β-hydroxyethyldimethylammonium chloride, polyethylenimine, polyallylamine, polyallylamine hydrochloride, polyamide-polyamine resin, cationic starch, dicyandiamido-formalin condensate, dimethyl-2-hydroxypropylammonium salt polymer, polyamidine and polyvinylamine.

The molecular weight of the polymer mordant is preferably 1,000 to 200,000, and more preferably 3,000 to 60,000 in terms of weight average molecular weight. When the molecular weight is in the range of 1,000 to 200,000, water resistance of the medium is prevented from being insufficient and deterioration in handling aptitude of the medium caused by excessively increased viscosity is prevented.

As the cationic non-polymer mordant, for example, water-soluble metal salts such as aluminum sulfate, aluminum chloride, aluminum polychloride or magnesium chloride are preferable.

Compounds Represented by Formulae (1) and (2)

The ink receiving layer preferably contains a compound represented by the following formula (1) and/or a compound represented by the following formula (2). These compounds represented by formulae (1) and (2) are solvents having high boiling points.
RO(CH₂CH₂O)ₙH Formula (1)

wherein R represents a saturated hydrocarbon group having 1 to 12 carbon atoms, an unsaturated hydrocarbon group having 1 to 12 carbon atoms, a phenyl group or an acyl group, and n represents an integer from 1 to 3.
RO(CH₂CH(CH₃)O)ₙH Formula (2)

wherein R represents a saturated hydrocarbon group having 1 to 12 carbon atoms, an unsaturated hydrocarbon group having 1 to 12 carbon atoms, a phenyl group or an acyl group, and n represents an integer from 1 to 3.

Inclusion of the compound represented by formula (1) and/or the compound represented by formula (2) in the ink receiving layer can suppress drying shrinkage of the ink receiving layer when a three-dimensional network structure (porous structure) is formed. It is thought that this is because the compounds represented by formulae (1) or (2) moderately inhibit hydrogen bondings between silanol groups on the surfaces of the vapor-phase-process silica particles and hydroxyl groups of polyvinyl alcohol. Thereby, cracks of the ink receiving layer when a three-dimensional network structure is formed can be prevented, and therefore production yield and quality of the information medium can be improved.

In formulae (1) and (2), R represents a saturated hydrocarbon group having 1 to 12 carbon atoms, an unsaturated hydrocarbon group having 1 to 12 carbon atoms, a phenyl group or an acyl group, and is preferably a saturated hydrocarbon group having 1 to 4 carbon atoms.

The number of carbon atoms in the saturated hydrocarbon group is 1 to 12, preferably 1 to 8, and more preferably 1 to 4. Examples of the saturated hydrocarbon group include alkyl groups and alicyclic hydrocarbon groups. The saturated hydrocarbon groups may be substituted by a substituent. Specific examples of the saturated hydrocarbon group include a methyl group, an ethyl group, a propyl group, a butyl group, and a hexyl group. Among these, a methyl group, an ethyl group, a propyl group, and a butyl group are preferable.

The number of carbon atoms of the unsaturated hydrocarbon group is 1 to 12, preferably 1 to 8, and more preferably 1 to 4. Examples of the unsaturated hydrocarbon group include alkenyl groups and alkynyl groups. The unsaturated hydrocarbon group may be substituted by a substituent. Specific examples of the unsaturated hydrocarbon group include a vinyl group, an allyl group, an ethynyl group, a 1,3-butadienyl group, and a 2-propynyl group, and among these, an allyl group is preferable.

The acyl group preferably has 1 to 8 carbon atoms and more preferably 1 to 4 carbon atoms. The acyl group may be substituted by a substituent. Specific examples of the acyl group include an acetyl group, a propionyl group, a butyryl group, and a valeryl group, and among these, a butyryl group is preferable.

In formulae (1) and (2), n represents an integer from 1 to 3, and is preferably 2 or 3.

The compounds represented by formulae (1) or (2) are preferably water-soluble compounds. Here, “water-soluble” compounds mean those soluble in water in an amount of 1 mass % or more

Specific examples of the compounds represented by formulae (1) or (2) include ethylene glycol monomethyl ether, ethylene glycol monoethyl ether, ethylene glycol monobutyl ether, ethylene glycol monohexyl ether, ethylene glycol monoallyl ether, ethylene glycol monphenyl ether, diethylene glycol monomethyl ether, diethylene glycol monoethyl ether, diethylene glycol monobutyl ether, diethylene glycol monohexyl ether, diethylene glycol monododecyl ether, triethylene glycol monomethyl ether, triethylene glycol monoethyl ether, triethylene glycol monobutyl ether, propylene glycol monomethyl ether, propylene glycol monoethyl ether and propylene glycol monobutyl ether. Among these compounds, diethylene glycol monobutyl ether and triethylene glycol monobutyl ether are preferable.

It is sufficient that the ink receiving layer contains at least one of the compounds represented by formulae (1) and (2). Therefore, the ink receiving layer may contain one or more compounds represented by formulae (1) or (2), or may contain a combination of the compound represented by formula (1) and the compound represented by formula (2). When the compound represented by formula (1) (amount: x) is combined with the compound represented by formula (2) (amount: y), the mixing ratio (mass ratio) x:y is not limited, but is preferably 100:1 to 100:100, and more preferably 100:10 to 100:50.

Further, a total content of the compounds represented by formulae (1) or (2) in the ink receiving layer is preferably 0.1 to 5.0 g/m², and more preferably 0.2 to 3.0 g/m² OTHER COMPONENTS

The ink receiving layer may contain the following components in accordance with necessity.

The ink receiving layer may contain an anti-color fading agent such as an ultraviolet absorbent, an antioxidant, or a singlet oxygen quencher for the purpose of suppressing deterioration of the colorant.

Examples of the ultraviolet absorbent include cinnamic acid derivatives, benzophenone derivatives and benzotriazolylphenol derivatives. Specific examples of the ultraviolet absorbent include butyl α-cyano-phenylcinnamate, o-benzotriazolephenol, o-benzotriazole-p-chlorophenol, o-benzotriazole-2,4-di-t-butylphenol and o-benzotriazole-2,4-di-t-octylphenol. Hindered phenol compounds may also be used as the ultraviolet absorbent, and specifically, phenol derivatives being substituted by a branched alkyl group or groups at at least one of the second and sixth positions.

Benzotriazole ultraviolet absorbents, salicylic acid ultraviolet absorbents, cyanoacrylate ultraviolet absorbents and oxalic acid anilide ultraviolet absorbents may also be used. These ultraviolet absorbents are described in JP-A Nos. 47-10537, 58-111942, 58-212844, 59-19945, 59-46646, 59-109055 and 63-53544, JP-B Nos. 36-10466, 42-26187, 48-30492, 48-31255, 48-41572, 48-54965 and 50-10726, U.S. Pat. Nos. 2,719,086, 3,707,375, 3,754,919 and 4,220,711.

A fluorescent whitening agent may also be used as the ultraviolet absorbent. Examples of the fluorescent whitening agent include cumarin fluorescent whitening agents. Specific examples of the cumarin fluorescent whitening agents are described, for example, in JP-B Nos. 45-4699 and 54-5324.

Examples of the antioxidant include those described in European Patent Application Laid-open Nos. 223,739, 309,401, 309,402, 310,551, 310,552 and 459,416, German Patent Laid-open No. 3,435,443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212 and U.S. Pat. Nos. 4,814,262 and 4,980,275.

Specific examples of the antioxidant include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine and 1-methyl-2-phenylindole.

The anti-color fading agents may be used singly or in combination of two or more of them. The anti-color fading agent may be water-solubilized, dispersed, emulsified or included in microcapsules.

An amount of the anti-color fading agent to be added is preferably 0.01 to 10% by mass based on a total amount of the ink receiving layer coating solution.

The ink receiving layer may further contain various inorganic salts in view of improving dispersibility of the inorganic pigment particles, and/or an acid or an alkali serving as a pH control agent.

The ink receiving layer may further contain metal oxide particles having electronic conductivity in view of suppressing frictional electrification and peeling electrification of a surface of the ink receiving layer, and any matting agent in view of decreasing frictional characteristics of a surface of the ink receiving layer.

A pore diameter of the ink receiving layer is preferably 0.005 to 0.030 μm, and more preferably 0.01 to 0.025 μm in terms of median diameter.

The percentage of void and the pore median diameter may be measured with a mercury porosimeter (trade name: PORESIZER™ 9320-PC2, manufactured by Shimadzu Corporation).

The ink receiving layer preferably has high transparency. As for a measure of transparency, the haze value of the ink receiving layer formed on a transparent film substrate is preferably 30% or less, and more preferably 20% or less.

The haze value may be measured with a haze meter (trade name: HGM-2DP, manufactured by Suga Test Instrument Co., Ltd.).

In what follows, the methods for forming the ink-receiving layers such as mentioned above will be described. The ink-receiving layer can be formed by coating a coating liquid containing, for instance, the compound represented by formula (1) and/or the compound represented by formula (2) that are mentioned above, particles and a binder (ink-receiving layer coating liquid) on a base layer. However, it may be formed as well according to a method where simultaneously with the coating, or in the middle of drying a formed coated layer and before the coated layer shows the falling-drying-rate, a solution containing a cross-linking agent and a mordant (cross-linking agent solution) is added, followed by cross-linking and curing a coated layer thereto the solution is added (WOW method; Wet On Wet method). In the method, the pH of the ink-receiving layer coating liquid is in the range of 8.0 to 10.0, that is, alkaline.

The ink receiving layer can also be obtained by simultaneously applying the ink receiving layer coating solution and the cross-linking agent solution to a substrate with a barrier solution including only a material or materials which do not react with the cross-linking agent interposed between these solutions, followed by curing the resultant coating layers. Here, the mordant is contained in at least one of the cross-linking agent solution and the barrier solution.

The mordant and the cross-linking agent (boron compound) are simultaneously applied to the substrate, whereby water resistance of the ink receiving layer can be improved, as mentioned above. To the contrary, if the mordant, which is cationic, is added to the ink receiving layer coating solution, which includes the vapor-phase-process silica having an anionic charge on the surface thereof, the mordant and the silica may aggregate. However, if a method is adopted in which a solution containing the mordant and the ink receiving layer coating solution are separately prepared and applied, it is unnecessary to take aggregation of the vapor-phase-process silica into account, which increases types of mordant which can be used.

The ink receiving layer coating solution containing at least the compound represented by formula (1) and/or the compound represented by formula (2), the vapor-phase-process silica and the polyvinyl alcohol may be prepared, for example, in the following manner.

The vapor-phase-process silica is added to water (for example, in an amount of 10 to 20% by mass), and the resultant mixture is stirred with a wet type colloid mill with a rotor which can rotate at a high speed (e.g., trade name: CLEARMIX, manufactured by M Technique Co. Ltd.,) at a high rotation speed of 10,000 rpm (preferably 5,000 to 20,000 rpm) for 20 minutes (preferably 10 to 30 minutes). Thereafter, an aqueous polyvinyl alcohol solution is added to the mixture (such that the mass of the PVA is about ⅓ of the mass of the vapor-phase-process silica). Furthermore, the compound represented by formula (1) and/or the compound represented by formula (2) are added to and dispersed in the resultant mixture under the same rotation conditions as above, whereby the ink receiving layer coating solution can be prepared. The resulting coating solution is uniform sol, which is applied to a substrate with the following coating method so as to form a porous ink receiving layer having a three-dimensional network structure.

Although conventionally known various dispersing machines such as a high rotation dispersing machine, a medium agitation type dispersing machine (e.g., a ball mill and a sand mill), an ultrasonic dispersing machine, a colloid mill dispersing machine and a high-pressure dispersing machine may be used in the dispersing treatment, a colloid mill dispersing machine or a high-pressure dispersing machine is preferably used in the invention in order to efficiently fine massive particles and disperse the resultant particles.

A cross-linking agent solution, a surfactant, a pH control agent, and/or an antistatic agent may be further added to the ink receiving layer coating solution, if necessary.

Application of the ink receiving layer coating solution may be carried out by other methods, for example, by a contact coating method such as bar coating, roll coating, blade coating, screen coating or pad coating, or a non-contact coating method such as spray coating, spin coating, curtain coating or dip coating. Application by extrusion die coater may be also used.

When the ink receiving layer coating solution is applied by spray coating, the pressure is preferably 1.013 to 2026 hPa, more preferably 50.65 to 1013 hPa, and still more preferably 101.3 to 506.5 hPa. The spread angle of the spray is preferably 1 to 120°, more preferably 10 to 60°, and still more preferably 20 to 50°. The liquid particle diameter is preferably 0.1 to 1,000 μm, more preferably 1 to 500 μm, and still more preferably 10 to 100 μm. The distance between the spray and a work (information medium) is preferably 1 to 1,000 mm, more preferably 10 to 200 mm, and still more preferably 30 to 100 mm. The temperature is preferably 10 to 40° C., more preferably 15 to 35° C., and still more preferably 20 to 30° C. The humidity is preferably 5 to 70% RH, more preferably 10 to 40% RH, and still more preferably 20 to 50% RH.

When the ink receiving layer coating solution is applied by spray coating, a desired layer thickness distribution can be obtained by increasing the diameters of arrayed plural nozzles, in accordance with the line speed, over the inner to outer peripheral portions of the disc.

In the case of a spin coating being adopted to coat, the viscosity of the coating liquid is preferably in the range of 0.1 to 10,000 mPa·s, more preferably in the range of 1 to 6,000 mPa·s, and furthermore preferably in the range of 10 to 3,000 mPa·s. The viscosity of the ink-receiving layer coating liquid is, in order to secure a thickness, preferably in the range of 50 to 10,000 mPa·s, more preferably in the range of 100 to 6,000 mPa·s, and furthermore preferably in the range of 200 to 3,000 mPa·s. The number of rotation is, at the time of dispense, preferably in the range of 10 to 1,000 rpm and more preferably in the range of 50 to 600 rpm and furthermore preferably in the range of 100 to 400 rpm. At the time of shaking off, the number of rotation is gradually increased, stepwise or smoothly. Specifically, it is preferably set to 100 to 10,000 rpm, more preferably 200 to 5,000 rpm and furthermore preferably 300 to 3,000 rpm. A shape of a nozzle is preferably in the range of 1 to 100 mm in the length, more preferably 5 to 50 mm, and still more preferably in the range of 10 to 30 mm. An inner diameter of the nozzle is preferably in the range of 0.1 to 5 mm, more preferably 0.3 to 3 mm, and still more preferably in the range of 0.5 to 2 mm. A thickness of the nozzle is preferably in the range of 0.1 to 1 mm and more preferably in the range of 0.2 to 0.5 mm. Furthermore, the nozzle may be disposed obliquely along a stream. A distance from a work is preferably in the range of 0.5 to 100 mm, more preferably 1 to 50 mm, and still more preferably in the 2 to 20 mm. The temperature is preferably set to 10 to 40° C., more preferably 15 to 35° C., and still more preferably 20 to 30° C. The humidity is preferably set in the range of 5 to 70% RH, more preferably in the range of 10 to 40% RH, and still more preferably in the range of 20 to 50% RH.

When a second solution (cross-linking agent solution) described below is applied by spin coating, in order to assure an evenness of the coated film a viscosity of the second solution is preferably in a range of 0.1 to 1,000 mPa·s, more preferably in a range of 1 to 500 mPa·s, and still more preferably in a range of 2 to 300 mPa·s.

After the ink receiving layer coating solution is applied to the substrate, the cross-linking agent solution is applied to the resultant coating layer. The cross-linking agent solution may be applied before the coating layer, which has been coated, exhibits a decreasing rate of dry speed. That is, the cross-linking agent and the mordant are introduced in the ink receiving layer during a period starting immediately after the ink receiving layer coating solution has been applied and ending before the coating layer exhibits a constant rate of dry speed.

Here, the term “before the coating layer exhibits a decreasing rate of dry speed” generally indicates a period starting immediately after the application of the ink receiving layer coating solution and ending several minutes just after the application. During this period, the coating layer exhibits a constant rate of dry speed, which means that the content of the solvent in the applied coating layer decreases in proportion with time. The period in which a constant rate of dry speed is observed is described in Chemical Engineering Handbook (pp. 707-712, published by Maruzen Co., Ltd., Oct. 25, 1980).

As mentioned above, after the ink-receiving layer coating liquid is coated, the coated layer is dried until it shows a falling-drying-rate. The drying conditions will be detailed below.

The coated layer of the ink-receiving layer can be dried by use of any of natural drying, hot air drying, low temperature set drying, IR/FIR drying, high frequency drying and oven drying.

In the case of the natural drying, a drying time of the coated layer is preferably set in the range of 0.1 to 10000 sec, more preferably in the range of 1 to 1000 sec and still more preferably in the range of 10 to 500 sec. A drying temperature is preferably set in the range of 0 to 40° C., more preferably in the range of 10 to 35° C. and still more preferably in the range of 20 to 30° C. A drying humidity is preferably set in the range of 10 to 70% RH, more preferably in the range of 20 to 60% RH and still more preferably in the range of 30 to 50% RH.

In the case of the hot air drying, a drying time of the coated layer is preferably set in the range of 0.1 to 5000 sec, more preferably in the range of 1 to 1000 sec and still more preferably in the range of 10 to 500 sec. A drying temperature is preferably set in the range of 40 to 200° C., more preferably in the range of 60 to 150° C. and still more preferably in the range of 80 to 130° C. A drying humidity is preferably set in the range of 0.01 to 50% RH, more preferably in the range of 0.1 to 30% RH and still more preferably in the range of 1 to 20% RH. A thickness of the dried ink-receiving layer is preferably in the range of 10 to 100 μm, more preferably in the range of 15 to 80 μm and still more preferably in the range of 20 to 50 μm.

In the case of the low temperature set drying, a drying temperature of the coated layer is preferably set in the range of 2 to 25° C. and more preferably in the range of 5 to 15° C. A drying humidity is preferably set in the range of 10 to 50% RH and more preferably in the range of 10 to 30% RH. The temperature and humidity are preferably gradually or stepwise elevated, as the drying proceeds, from low temperature and low humidity to high temperature and high humidity. The wind speed, when the falling-drying-rate is observed, is preferably set to 3 m/sec or more in parallel to the coated layer.

In the case of the IR/FIR drying, a drying time of the coated layer is preferably set in the range of 0.1 to 1000 sec, more preferably in the range of 1 to 500 sec and still more preferably in the range of 10 to 300 sec. An output power is set preferably in the range of 10 to 2000 W, more preferably in the range of 50 to 1500 W and still more preferably in the range of 100 to 1000 W In the case of the high frequency drying, the drying conditions are similar to that of the IR/FIR drying.

In the case of the oven drying, a drying time of the coated layer is preferably set in the range of 0.1 to 1,000 sec, more preferably in the range of 1 to 500 sec and still more preferably in the range of 10 to 300 sec.

Examples of a method of applying the cross-linking agent before the coating layer exhibits a decreasing rate of dry speed include (1) a method in which the cross-linking agent solution is applied onto the coating layer, (2) a method in which the solution is sprayed, and (3) a method in which a substrate on which the coating layer has been formed is dipped in the cross-linking agent solution.

In the method (1) above, as a method of coating a cross-linking agent solution, known coating methods that use coaters such as a curtain flow coater, an extrusion die coater an air doctor coater, a bread coater, a rod coater, a knife coater, a squeeze coater, a reverse roll coater and a bar coater can be used. Among these coaters, the extrusion die coater, curtain flow coater or bar coater where the coater does not come into contact directly with the coated layer can be preferably used.

An amount of coated cross-linking agent solution that is coated on the ink-receiving layer and contains at least the cross-linking agent and a mordant is generally in the range of 0.01 to 10 g/m² and preferably in the range of 0.05 to 5 g/m² in terms of the cross-linking agent.

The cross-linking agent solution, after coating, is generally heated at a temperature in the range of 40 to 180° C. for 0.5 to 30 min to dry and cure. Among these, the heating is preferably applied at a temperature in the range of 40 to 150° C. for 1 to 20 min.

When, for instance, borax or boric acid is used as a boron compound in the cross-linking agent solution, it is preferably heated at a temperature in the range of 60 to 100° C. for 5 to 20 min.

Also, the cross-linking agent coating solution may be applied simultaneously with the application of the ink receiving layer coating solution.

In this case, the ink receiving layer coating solution and the cross-linking agent solution can be simultaneously applied (multilayer application) to a substrate such that both solutions are in contact with the substrate. Thereafter, the resultant coating layers are dried and cured, whereby the ink receiving layer can be formed.

The simultaneous coating (overlaying coating) can be performed by use of a coating method that uses for instance an extrusion die coater or a curtain flow coater. After the simultaneous coating, the formed coating layer is dried. The drying is generally performed by heating the coated layer at a temperature in the range of 40 to 150° C. for 0.5 to 10 min, and preferably at a temperature in the range of 40 to 100° C. for 0.5 to 5 min. When, for instance, borax or boric acid is used as a boron compound in the cross-linking agent solution, it is preferably heated at a temperature in the range of 60 to 100° C. for 5 to 20 min.

When an extrusion die coater is used to carry out the simultaneous application (multilayer application), the two coating solutions simultaneously discharged are formed into layers in the vicinity of the outlet of the extrusion die coater, namely, before they are transferred to a substrate. In this state, they are applied as layers on the substrate. The two layer coating solutions which have been multi-layered easily cause cross-linking reaction at the boundary thereof. Accordingly, these two discharged solutions are mixed and easily thicken in a portion of the extrusion die coater which portion is near the outlet. This may hinder coating operation. Therefore, when these two solutions are simultaneously applied as mentioned above, a barrier layer solution (intermediate layer solution) including only a material or materials which do not react with the cross-linking agent is preferably interposed between the two solutions. In other words, it is preferable that the ink receiving layer coating solution, the barrier layer solution, and the cross-linking agent solution containing the cross-linking agent and the mordant are simultaneously applied to carry out simultaneous triple layer application.

The material(s) of the barrier layer solution can be any substance which does not react with the cross-linking agent and which can form a liquid layer. Examples of the barrier layer solution include water, and an aqueous solution containing a trace of a water-soluble resin that does not react with the cross-linking agent. The water-soluble resin is used in view of, for example, viscosity-increasing, and selected in consideration of coatability. Examples of the water-soluble resin include polymers such as hydroxypropylmethyl cellulose, methyl cellulose, hydroxyethylmethyl cellulose, polyvinylpyrrolidone and gelatin.

It is noted that the barrier layer solution may further contain the mordant.

The ink receiving layer may be formed by a method in which: a coating solution, which is obtained by adding to and redispersing in an aqueous dispersion including the particles and a dispersing agent each of a solution (first solution) containing the compound represented by formula (1) and/or the compound represented by formula (2) and the binder and another solution (second solution) containing the cross-linking agent and the mordant; the coating solution is applied onto the base layer so as to form the coating layer; and the coating layer is cured. A pH of the coating solution used to form the ink receiving layer in this method is 2.5 to 4.0, and the coating solution shows acidity. Use of this method improves glossiness and density of a printed image and is therefore preferable.

Specific examples of a drying method and condition for this method include those described in “Chemistry and Technology of Water-Soluble Polymers” edited by C. A. Finchi (1983).

As the dispersing agent, a cationic polymer may be used. Preferable examples of the cationic polymer include a homopolymer of a monomer having any of primary to tertiary amino groups and salts thereof and a quaternary ammonium base, and a copolymer or a condensed polymer formed of the monomers and any other monomers. The dispersing agent is preferably used in a form of a water-soluble polymer.

A molecular weight of the dispersing agent is preferably 1,000 to 200,000, and more preferably 3,000 to 60,000 in terms of a weight average molecular weight. When the molecular weight is smaller than 1,000, dispersibility of the dispersing agent may become insufficient. When the molecular weight exceeds 200,000, a viscosity of the aqueous dispersion may increase. An amount of the dispersing agent is preferably 1% to 30% and more preferably 3% to 20% with respect to the amount of vapor-phase-process silica. When the amount is less than 1%, inferior dispersibility may be obtained. When the amount exceeds 30%, color density may decrease at the time that an image is formed on the ink receiving layer.

When the aqueous dispersion including the particles and the dispersing agent is prepared, an aqueous dispersion of the particles may be prepared in advance and added to an aqueous solution of the dispersing agent. Alternatively, the aqueous solution of the dispersing agent may be added to the aqueous dispersion of the particles, or the aqueous dispersion and the aqueous solution may be simultaneously mixed. Also, powder of the particles rather than the aqueous dispersion thereof may be added to the aqueous solution of the dispersing agent.

After the particles are mixed with the dispersing agent, the resultant mixed solution may be stirred with a dispersing machine to particles contained therein. Thus, an aqueous dispersion with an average particle diameter of 50 to 300 nm can be obtained. Although conventionally known various dispersing machines such as a high rotation dispersing machine, a medium agitation type dispersing machine (e.g., a ball mill and a sand mill), an ultrasonic dispersing machine, a colloid mill dispersing machine and a high-pressure dispersing machine may be used as the dispersing machine used to obtain the aqueous dispersion, a colloid mill dispersing machine or a high-pressure dispersing machine is preferably used in order to efficiently fine massive particles and disperse the resultant particles.

Examples of the solvent used in the coating solution include water, an organic solvent, and a mixed solvent thereof. Examples of the organic solvent include alcohols such as methanol, ethanol, n-propanol, iso-propanol and methoxypropanol, ketones such as acetone and methyl ethyl ketone, tetrahydrofuran, acetonitrile, ethyl acetate and toluene.

A coating solution, which is obtained by adding to and redispersing in an aqueous dispersion including the particles and a dispersing agent each of a solution (first solution) containing the compound represented by formula (1) and/or the compound represented by formula (2) and the binder and another solution (second solution) containing the cross-linking agent and the mordant, can be applied onto the base layer in the same manner as that for coating the ink receiving layer coating solution.

After the ink receiving layer is formed on the base layer, the ink receiving layer may be calendered with, for example, a super calender or a gloss calender. Specifically, the ink receiving layer may be made to pass between a roll nip while the ink receiving layer is being heated and pressurized. This makes it possible to improve surface smoothness, glossiness, transparency and coating layer strength. However, the calendering treatment sometimes causes a reduction in percentage of void (namely, ink absorbing ability may deteriorate) and it is therefore necessary to conduct calendering with a setting of a condition in accordance with which the degree of reduction in percentage of void is low.

A roll temperature for conducting the calendering treatment is preferably 30 to 150° C., and more preferably 40 to 100° C.

A linear load between rolls for conducting the calendering treatment is preferably 50 to 400 kg/cm, and more preferably 100 to 200 kg/cm.

Intermediate Layer

The information medium of the invention may have an intermediate layer between the ink receiving layer and the base layer. When the intermediate layer has high ink absorbing ability, the amount of ink which the information medium can receive is increased, and color density and image quality can be improved at the time of image printing. Alternatively, the intermediate layer can be provided between the base layer and the substrate. In this case, it is possible to improve adhesion between the base layer and the substrate and to control warpage of the entire information medium.

The thickness of the intermediate layer is preferably 0.1 to 100 μm, more preferably 1 to 50 μm, and most preferably 3 to 20 μm.

Surface Layer

The information medium of the invention may have a surface layer on or above the ink receiving layer. Providing the surface layer can further improve a surface strength and preservability of a printed image. The surface layer is required to receive ink, or has a characteristic to quickly pass ink through the surface layer.

The thickness of the surface layer is preferably 0.01 to 100 μm, more preferably 0.1 to 10 μm, and most preferably 0.5 to 5 μm.

The information medium obtained by the manufacturing method of the invention can exhibit a glossiness of 30% or more at 60°. The glossiness may be measured with a digital variable gloss meter (trade name: UGV-50DP, manufactured by Suga Test Instrument Co., Ltd.) or the like.

When the information medium obtained according to a manufacturing method of the invention is an optical information recording medium, on the substrate, a recording layer and a reflective layer are formed. In this connection, the substrate and the respective layers (recording layer and reflective layer) that are used in the invention and the forming methods thereof will be described. Layer configurations and materials are only examples and the invention is not restricted thereto.

Substrate

The substrate can be made of any material selected from various materials which are used as substrate materials of conventional optical recording media.

Specific examples of the substrate material include glass; polycarbonates; acrylic resins such as polymethyl methacrylate; vinyl chloride resins such as polyvinyl chloride and vinyl chloride copolymers; epoxy resins; amorphous polyolefins; polyesters; and metals such as aluminum. These materials may be combined, if desired.

Among the above materials, amorphous polyolefins and polycarbonates are preferable and polycarbonates are particularly preferable from the viewpoints of humidity resistance, dimensional stability, and low cost. The thickness of the substrate is preferably 0.5 to 1.2 mm, and more preferably 0.6 to 1.1 mm.

A guide groove or grooves for tracking, or an irregularity or irregularities (pre-groove) representing information such as address signals are formed on the substrate.

In a case of a medium in which information is recorded with a bluish violet laser (Blue-ray Discs or HD DVDs), a track pitch of the pre-groove(s) is preferably in a range of 200 to 800 nm, more preferably in a range of 200 to 500 nm, and still more preferably in a range of 200 to 400 nm.

Further, a depth of the pre-groove(s) (groove depth) is preferably in a range of 10 to 180 nm, and more preferably in a range of 20 to 150 nm.

Moreover, a half breadth of the pre-groove(s) is preferably in a range of 200 to 400 nm, more preferably in a range of 230 to 380 nm, and still more preferably in a range of 250 to 350 nm.

In a case of DVD-Rs or DVD-RWs, a track pitch of a pre-groove(s) is preferably in a range of 300 to 900 nm, more preferably in a range of 350 to 850 nm, and still more preferably in a range of 400 to 800 nm.

Further, the depth of the pre-groove(s) (groove depth) is preferably in a range of 100 to 160 nm, more preferably in a range of 120 to 150 nm, and still more preferably in a range of 130 to 140 nm.

Moreover, a half breadth of the pre-groove(s) is preferably in a range of 200 to 400 nm, more preferably in a range of 230 to 380 nm, and still more preferably in a range of 250 to 350 nm.

In a case of CD-Rs or CD-RWs, a track pitch of a pre-groove(s) is preferably in a range of 1.2 to 2.0 μm, more preferably in a range of 1.4 to 1.8 μm, and still more preferably in a range of 1.55 to 1.65 μm.

Further, a depth of the pre-groove(s) (groove depth) is preferably in a range of 100 to 250 nm, more preferably in a range of 150 to 230 nm, and still more preferably in a range of 170 to 210 nm.

Moreover, a half breadth of the pre-groove(s) is preferably in a range of 400 to 650 nm, more preferably in a range of 480 to 600 nm, and still more preferably in a range of 500 to 580 nm.

Recording Layer

In a case of CD-Rs DVD-Rs, HD DVDs, or Blue-ray Discs, a recording layer is formed in the following manner. A dye serving as a recording material and a binder are dissolved in a proper solvent and then the resulting coating solution is applied to the surface of the substrate, on which surface the pre-groove is formed, by a spin coating method to form a coating layer, followed by drying.

The temperature in the spin coating method is preferably 23° C. or more, and more preferably 25° C. or more. Although there is not any particular limitation to the upper limit of the temperature, the temperature must be lower than the flash point of the solvent and is preferably 35° C.

When the temperature is lower than 23° C., the drying rate of the solvent slows down and therefore an intended dye layer thickness (thickness of the recording layer) may not be obtained. Moreover, the application and drying require more time, reducing productivity.

Examples of the dye include a cyanine dye, an oxonol dye, a metal complex dye, an azo dye and a phthalocycanine dye. Among these dyes, a phthalocycanine dye is preferable.

Dyes described in JP-A Nos. 4-74690, 8-127174, 11-53758, 11-334204, 11-334205, 11-334206, 11-334207, 2000-43423, 2000-108513 and 2000-158818 are also preferably used.

Examples of the solvent of the coating solution include esters such as butyl acetate, ethyl lactate and 2-methoxyethyl acetate; ketones such as methyl ethyl ketone, cyclohexanone and methyl isobutyl ketone; chlorinated hydrocarbons such as dichloromethane, 1,2-dichloroethane and chloroform; amides such as dimethylformamide; hydrocarbons such as methylcyclohexane; ethers such as tetrahydrofuran, ethyl ether and dioxane; alcohols such as ethanol, n-propanol, iso-propanol, n-butanol and diacetone alcohol; fluorinated solvents such as 2,2,3,3-tetrafluoropropanol; and glycol ethers such as ethylene glycol monomethyl ether, ethylene glycol monoethyl ether and propylene glycol monomethyl ether.

These solvents may be used singly or in combination of two or more of them in consideration of solubility of the recording material. Various additives such as an antioxidant, a UV absorbent, a plasticizer and a lubricant may be added to the coating solution according to the purpose.

When the coating solution includes a binder, examples of the binder include natural organic polymer materials such as a gelatin, cellulose derivative, dextran, rosin and rubber; and synthetic organic polymers such as hydrocarbon resins, e.g., polyethylene, polypropylene, polystyrene and polyisobutylene, vinyl resins, e.g., polyvinyl chloride, polyvinylidene chloride and polyvinyl chloride/polyvinyl acetate copolymer, acrylic resins, e.g., poly(methyl acrylate) and poly(methyl methacrylate), polyvinyl alcohol, chlorinated polyethylene, epoxy resins, butyral resins, rubber derivatives and initial condensates of thermosetting resins such as phenol/formaldehyde resins. When the binder is used as one of materials of the recording layer, the amount of the binder is usually 0.01 to 50 times, and preferably 0.1 to 5 times as much as that of the recording material in terms of mass ratio. The concentration of the recording material in the coating solution prepared in the above manner is generally in the range of 0.01 to 10% by mass, and preferably 0.1 to 5% by mass.

The coating method can be a spin coating method as mentioned above. An apparatus used in this method can be those conventionally known.

The recording layer may be formed as a single layer or multi layers. A thickness thereof is generally in a range of 20 to 500 nm, preferably in a range of 30 to 300 nm, and more preferably in a range of 50 to 100 nm.

The recording layer may contain various anti-color fading agent(s) to improve light fastness of the recording layer.

A singlet oxygen quencher is generally used as the anti-color fading agent. Examples of the singlet oxygen quencher include those described in publications such as already known patent specifications.

Specific examples of the singlet oxygen quencher include those described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995 and 4-25492, JP-B Nos. 1-38680 and 6-26028, German Patent No. 350,399 and Journal of Japan Chemical Society, the October issue, 1992, page 1141.

An amount of the singlet oxygen quencher is usually in a range of 0.1 to 50% by mass, preferably in a range of 0.5 to 45% by mass, more preferably in a range of 3 to 40% by mass, and still more preferably in a range of 5 to 25% by mass based on the amount of the dye.

In a case of CD-RWs, DVD-RWs, HD DVDs, or Blue-ray Discs, the recording layer is preferably made of an optical recording material whose phase can change, which is constituted of at least Ag, Al, Te and Sb, and which can take at least two states including a crystal state and an amorphous state. Such a recording layer can be formed by a known method.

A known dielectric layer may be formed on the recording layer in accordance with necessity.

Optical Reflecting Layer

After the recording layer is formed, a light reflecting layer is formed on the recording layer by vapor deposition, sputtering or ion plating a light reflecting material. When the light reflecting layer is formed, a mask is usually used, whereby an area where the light reflecting layer is formed can be controlled.

The light reflecting layer contains a light reflecting material having a high reflectance with respect to laser light. The reflectance is preferably 70% or more.

Examples of the light reflecting material having a high reflectance include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, and stainless steel. These light reflecting materials may be used singly, in combination of two or more of them, or can be used as an alloy. Among these materials, Cr, Ni, Pt, Cu, Ag, Au, Al and stainless steel are preferable, Au, Ag, Al and alloys of these metals are more preferable, and Au and Ag and alloys of these metals are most preferable.

A thickness of the light reflecting layer is usually in a range of 10 to 300 nm, and preferably in a range of 50 to 200 nm.

Protective Layer and Protective Substrate

After the light reflecting layer is formed, a protective layer is formed on the light reflecting layer.

The protective layer is formed by a spin coating method. Use of the spin coating method makes it possible to form a protective layer without damaging the recording layer (e.g., dissolution of dyes and chemical reaction between the dye and the protective layer materials). The number of rotations in the spin coating is preferably 50 to 8,000 rpm, and more preferably 100 to 5,000 rpm from the viewpoint of formation of a uniform layer and prevention of any damage to the recording layer.

When a radiation-curable resin (ultraviolet ray-curable resin) is used as the protective layer material, the protective layer is formed by a spin coating method and then irradiated with ultraviolet rays from an ultraviolet ray radiation lamp (metal halide lamp) to cure the ultraviolet ray-curable resin.

The protective layer can be allowed to stand for a fixed time before the resin is cured in order to prevent formation of a protective layer having uneven thickness.

The protective layer prevents ingress of moisture and generation of scratches. The material of the protective layer is preferably a radiation-curable resin, a visible ray-curable resin, a thermosetting resin or silicon dioxide, and particularly preferably a radiation-curable resin. Examples of the radiation-curable resin include ultraviolet ray-curable resins such as “SD-640” (trade name, manufactured by Dainippon Ink and Chemicals Incorporated), and “SD-347” (trade name, manufactured by Dainippon Ink and Chemicals Incorporated), “SD-694” (trade name, manufactured by Dainippon Ink and Chemicals Incorporated), or “SKCD1051” (trade name, manufactured by SKC) may also be used. A thickness of the protective layer is preferably in a range of 1 to 200 μm, and more preferably in a range of 50 to 150 μm.

In a layer structure in which the protective layer is used as a laser optical path, the protective layer must have transparency. Here, the term “transparency” means that the protective layer is transparent (transmittance: 90% or more) enough to transmit recording light and reproducing light. In case of Blue-ray Discs, a transparent sheet having the thickness of about 0.1 mm is provided as a protective layer.

In a case of DVD-Rs, DVD-RWs, and HD DVDs, an adhesive layer made of an ultraviolet ray-curable resin and a protective substrate having a thickness of about 0.6 mm and made of the similar material as that of the substrate are laminated on the light reflecting layer in place of the protective layer.

That is, after the light reflecting layer is formed, an ultraviolet ray-curable resin (e.g., SD640 as described above) is applied to the light reflecting layer by a spin coating method to form an adhesive layer having a thickness of 20 to 60 μm. Then, a polycarbonate substrate (thickness: 0.6 mm) serving as a protective substrate is put on the formed adhesive layer, and the resultant is irradiated with ultraviolet rays from the substrate side to cure the ultraviolet ray-curable resin and bond these layers and the protective substrate.

The information medium, which has a laminate including on the substrate the recording layer, the light reflecting layer, and the protective layer or the adhesive layer and the protective substrate (dummy substrate), wherein a printable layer is formed on the label side, is manufactured in the above manner.

As for the thickness of the information medium of the invention, the lower limit of thickness is preferably 0.3 mm, more preferably 0.5 mm, and still more preferably 0.7 mm. Also, the upper limit of thickness is preferably 100 mm, more preferably 20 mm, and still more preferably 5 mm. When the information medium is too thin, defects may occur by bending it. When the information medium is too thick, inferior removability may be obtained.

### EXAMPLES

The invention will be explained in more detail by way of examples, which are not intended to limit the invention. In the examples, all designations of parts and % indicate parts by mass and mass percentage (% by mass), respectively.

A polycarbonate substrate (trade name: PANLIGHT AD5503, manufactured by Teijin Limited, thickness: 0.6 mm, outer diameter: 120 mm, inner diameter: 15 mm) formed by injected molding machine and having a spiral groove (land) and LPP on the surface thereof was prepared. A depth of the track, a track width, and a track pitch were 140 nm, 310 nm, and 740 nm, respectively.

1 g of a die mixture containing an oxonol die (A) and an oxonol die (B) shown below at the mass ratio of 65:35 was dissolved in 100 ml of 2,2,3,3-tetrafluoro-propanol so as to prepare a recording layer forming coating solution. The recording layer forming coating solution was coated by spin coating on a grooved surface of the obtained substrate while changing a revolution speed from 300 to 3000 rpm, and was dried so as to form a recording layer. Thicknesses of the recording layer was measured by observing a cross section of the recording layer with an SEM, and was found to be 150 nm at a groove and 110 nm at a land portion.

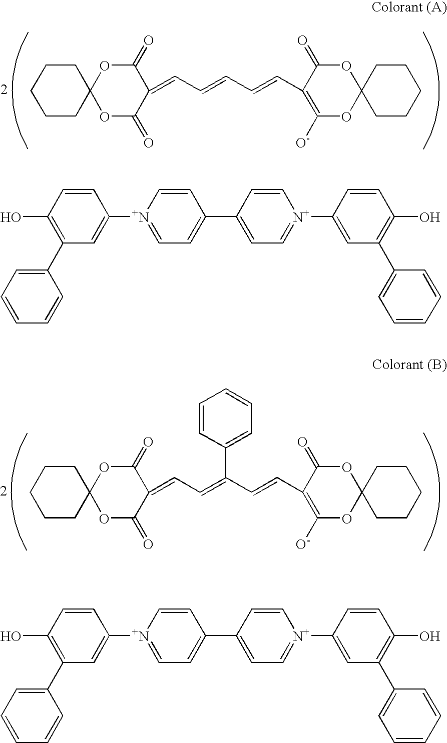

Subsequently, a light reflection layer, which consists of Ag and has a thickness of about 150 nm, was formed on the recording layer by DC sputtering in an Ar atmosphere. The pressure in the chamber was 0.5 Pa.

Further, a UV curable resin (trade name: SD-318, manufactured by Dainippon Ink and Chemicals Inc.) was dispensed on the light reflection layer, in a ring shape. Furthermore, a separately-prepared disc-shaped protective substrate (diameter: 120 mm, thickness: 0.6 mm) made of polycarbonate was placed thereon with center alignment, and was rotated at a revolution speed of 5000 rpm for 3 seconds, and a UV curable resin (trade name: SD-640, manufactured by Dainippon Ink and Chemicals Inc.) was spread out over the entire surface thereof and spun so as to spin off an excessive amount of UV curable resin. When the UV curable resin had spread out over the entire surface, UV light was irradiated thereon by using a high pressure mercury vapor lamp so as to cure the UV curable resin. In this manner, the disc-shaped protective substrate was affixed to the substrate having the recording layer and the light reflection layer formed thereon. The thickness of the affixing layer was 25 μm, and it was affixed without air bubbles entering there between.

Subsequently, a printable layer was formed on a surface of the disc-shaped protective substrate (label side) opposite to the laser light incident surface thereof in the following manner (printable layer forming process).

In the beginning, in an outer peripheral region and in an inner peripheral region of a label side, similarly to the formation of a base layer described below, by use of the screen printing method, a convex portion is formed. A height of the convex portion is 30 μm and the maximum width thereof is 1.0 mm. The convex portion of the outer peripheral region is disposed in the range of 0.5 to 1.0 mm from an outer peripheral end portion of the substrate and the convex portion of the inner peripheral region is disposed in the range of 10 to 17 mm from the inner peripheral end portion of the substrate.

Next, between the convex portion on an outer peripheral side of the substrate and the convex portion on the inner peripheral side thereof, a UV-curable ink (trade name: White No. 3, manufactured by Teikoku Ink Corp.) is printed by use of the screen printing method, followed by irradiating UV light of 80 W/cm metal halide lamp thereupon to cure to form a 8 μm thick base layer (white layer), further followed by repeating the same to form a base layer having a thickness of 16 μm in total. As a screen, a screen manufactured by Tetron of which mesh is 300 l/inch, thread diameter is 31 μm and opening is 38 μm is used.

Next, the following process was carried out to form an ink receiving layer on the base layer.

Preparation of Ink Receiving Layer Coating Solution

(1) Vapor-phase-process silica particles and (2) ion-exchanged water, which are described in the following composition, were mixed and the resultant was stirred for 20 minutes at 10,000 rpm with a high-speed rotary colloid mill (trade name: CLEARMIX, manufactured by M technique Co., Ltd.). Then, a first solution containing (3) polyoxyethylene lauryl ether, (4) an aqueous 9% polyvinyl alcohol solution and (5) diethylene glycol monobutyl, and a second solution containing (6) boric acid, (7) mordant and (8) ion-exchanged water were respectively added to the resultant water dispersion, and the mixture was dispersed in the same conditions as above to prepare an ink receiving layer coating solution A.

A ratio by mass of the silica particles to the water-soluble resin (PB ratio of the component (1): the component (4)) was 3.5:1 and a pH of the ink receiving layer coating solution A was 3.4, and the ink receiving layer showed acidity.

Composition of Ink Receiving Layer Coating Solution a

| Composition of Ink receiving layer coating solution A | | |
|---|---|---|
| (1) Vapor-phase-process silica particles (inorganic pigment | 10.0 | parts |
| microparticle) (average primary particle diameter: 7 nm) | | |
| (trade name: AEROSIL ® 300, manufactured by Nippon | | |
| Aerosil Co., Ltd.) | | |
| (2) Ion-exchanged water | 55.2 | parts |
| Composition of First solution | | |
| (3) Polyoxyethylene lauryl ether (surfactant) (trade name: | 3.5 | parts |
| EMULGEN 109P (10%), manufactured by Kao | | |
| Corporation, HLB value: 13.6) | | |
| (4) 9% aqueous solution of polyvinyl alcohol (water-soluble | 31.7 | parts |
| resin) (trade name: PVA420, manufactured by Kuraray Co., | | |
| Ltd., degree of saponification: 81.8%, degree of | | |
| polymerization: 2,000) | | |
| (5) Diethylene glycol monobutyl ether (compound | 0.5 | parts |
| represented by formula (1)) | | |
| Composition of Second solution | | |
| (6) Boric acid (concentration: 6%) (cross-linking agent) | 10.4 | parts |
| (7) Mordant (trade name: PAS-F5000 (concentration: 20%), | 2.5 | parts |
| manufactured by Nitto Boseki Co., Ltd.) | | |
| (8) Ion-exchanged water | 5.3 | parts |

Formation of Ink-Receiving Layer

After a Corona discharge treatment is applied on a surface of a base layer of the information medium, an ink-receiving layer coating liquid A obtained from the above is coated on the base layer by use of an extrusion die coater. Thereafter, in an environment of 5° C. and 10% RH in a low temperature and low humidity chamber, the drying is applied until the fluidity of the coating liquid on the surface is suppressed. The coated layer shows a constant-drying-rate during this period. Immediately thereafter, a hot air dryer is used to dry in an environment of 20° C. and 20% RH (wind speed: 4 m/sec) for 10 min. Thereby, an information medium provided with an ink-receiving layer having a dry film thickness of 35 μm is prepared.

When appearance of the information medium is visually observed, there is found no liquid that goes slack to an end. Furthermore, when, with a micrometer, thicknesses before and after coating are measured and compared to investigate fluctuation of a film thickness in the printable layer, it is found that the film thickness is substantially uniform. Also when a base layer is formed by use of a screen printing method followed by disposing convex portions on each of an outer peripheral side and an inner peripheral side, an excellent result similar to the above can be obtained.

As mentioned above, according to the invention, a method for manufacturing a disc-shaped information medium, which when an ink-receiving layer is formed on a label side to prepare a disc-shaped information medium, at the time of coating an ink-receiving layer coating liquid or at the time of drying after the coating, the ink-receiving layer coating liquid can be prevented from going slack to an end face of the disc, and thereby a thickness of the coated layer can be made uniform, can be provided.

What is claimed is:

1. A method for manufacturing a disc-shaped information medium that has, on a substrate, a printable layer containing at least a base layer and an ink-receiving layer, the method comprising:
performing a liquid spread prevention treatment at an outer peripheral region from an outer peripheral end portion of the substrate to an outer peripheral end portion of the ink-receiving layer; and
coating an ink-receiving layer coating liquid for forming the ink-receiving layer onto the base layer to form the printable layer.

2. The method for manufacturing a disc-shaped information medium according to claim 1, further performing the liquid spread prevention treatment at an inner peripheral region from an inner peripheral end portion of the substrate to an inner peripheral end portion of the ink-receiving layer; and
coating the ink-receiving layer coating liquid onto the base layer.

3. The method for manufacturing a disc-shaped information medium according to claim 1, wherein the liquid spread prevention treatment is a treatment that involves forming a convex portion on the substrate.

4. The method for manufacturing a disc-shaped information medium according to claim 1, wherein the liquid spread prevention treatment is a treatment that involves forming a convex portion wherein the height of the convex portion and the thickness of the ink-receiving layer are substantially the same.

5. The method for manufacturing a disc-shaped information medium according to claim 1, wherein the ink-receiving layer coating liquid comprises particles, a binder and a cross-linking agent.

6. The method for manufacturing a disc-shaped information medium according to claim 5, wherein the particles are at least one kind of particle selected from the group consisting of vapor-phase-process silica, pseudo-boehmite and aluminum oxide.

7. The method for manufacturing a disc-shaped information medium according to claim 5, wherein the binder is polyvinyl alcohol.

8. The method for manufacturing a disc-shaped information medium according to claim 5, wherein the cross-linking agent is a boron compound.

9. The method for manufacturing a disc-shaped information medium according to claim 5, wherein the ink-receiving layer coating liquid further comprises a mordant.

10. The method for manufacturing a disc-shaped information medium according to claim 5, wherein the ink-receiving layer coating liquid comprises at least one of a compound represented by the following formula (1) or a compound represented by the following formula (2):
RO(CH₂CH₂O)ₙH Formula (1)
wherein R represents a saturated hydrocarbon group having from 1 to 12 carbon atoms, an unsaturated hydrocarbon group having from 1 to 12 carbon atoms, a phenyl group or an acyl group; and n represents an integer of from 1 to 3,
RO(CH₂CH(CH₃)O)ₙH Formula (2)
wherein R represents a saturated hydrocarbon group having from 1 to 12 carbon atoms, an unsaturated hydrocarbon group having from 1 to 12 carbon atoms, a phenyl group or an acyl group; and n represents an integer of from 1 to 3.

11. The method for manufacturing a disc-shaped information medium according to claim 10, wherein the compound represented by formula (1) and the compound represented by formula (2) are water-soluble.

12. The method for manufacturing a disc-shaped information medium according to claim 10, wherein R in formula (1) and formula (2) is a saturated hydrocarbon group having 1 to 4 carbon atoms.
